(19) United States
(12) Patent Application Publication
(10) Pub. No.: US 2024/0227788 A9
(43) Pub. Date: Jul. 11, 2024

(54) METHOD AND SYSTEM FOR COLLISION AVOIDANCE

(71) Applicant: Volvo Car Corporation, Göteborg (SE)

(72) Inventors: Ashok Chaitanya Koppisetty, Göteborg (SE); Alexander Eriksson, Göteborg (SE); Patrik Johansson, Göteborg (SE); Par Nilsson, Göteborg (SE)

(21) Appl. No.: 17/972,645

(22) Filed: Oct. 25, 2022

(51) Int. Cl. B60W 30/09; B60C 23/00; B60T 1/14; B60W 10/18; B60W 10/20

(52) U.S. Cl. CPC B60W 30/09; B60C 23/002; B60T 1/14; B60W 10/18; B60W 10/20; B60W 2420/42; B60W 2420/52; B60W 2420/54; B60W 2510/18; B60W 2510/20; B60W 2520/06; B60W 2520/10; B60W 2552/40

(57) ABSTRACT

A method and system for collision avoidance that goes beyond automatic steering and braking. A trained artificial intelligence (AI)/machine learning (ML) system is used to detect an impending impact event that exceeds a predetermined severity threshold based on received sensor and vehicle operational data. Upon detecting such an impending impact event, vehicle systems are deployed to avoid or lessen the severity of the impending impact event. These vehicle systems include automatic steering and braking, and automatic tire flattening and vehicle anchor deployment which are intended to stop or slow the vehicle before impact.

### TECHNICAL FIELD

The present disclosure relates generally to the automotive field. More particularly, the present disclosure relates to a method and system for collision avoidance.

### BACKGROUND

Most modern vehicles are equipped with robust sensor and processing technologies. Some of these vehicles also include basic collision avoidance technologies, such as automatic steering and braking, that are deployed when an impeding impact event is detected by the sensor and processing technologies in general.

This background is provided as illustrative environmental context only and is not intended to be limiting in any manner. It will be readily apparent to those of ordinary skill in the art that the concepts and principles of the present disclosure may be implemented in other environmental contexts equally.

### SUMMARY

The present disclosure provides a method and system for collision avoidance that goes beyond automatic steering and braking. A trained artificial intelligence (AI)/machine learning (ML) system is used to detect an impending impact event that exceeds a predetermined severity threshold based on received sensor and vehicle operational data. Upon detecting such an impending impact event, vehicle systems are deployed to avoid or lessen the severity of the impending impact event. These vehicle systems include automatic steering and braking, and automatic tire flattening and vehicle anchor deployment which are intended to stop or slow the vehicle before impact.

In one illustrative embodiment, the present disclosure provides a method for automatically avoiding a vehicle collision, the method including: receiving sensor data from a sensor coupled to a vehicle and operational state data from an electronic control unit of the vehicle; determining that an impact event is impending based on the sensor data and the operational state data; determining that the impact event exceeds a predetermined severity threshold; and deploying a collision avoidance measure to avoid or lessen a severity of the impact event. The collision avoidance measure may include one or more of automatic steering and automatic braking. The collision avoidance measure may also include automatic tire flattening. The collision avoidance measure may further include vehicle anchor deployment. The sensor includes one or more of a camera, a lidar sensor, a radar sensor, and an ultrasonic sensor. The operational state data includes one or more of a speed of the vehicle, a trajectory of the vehicle, a steering state of the vehicle, a braking state of the vehicle, and a road friction state of the vehicle. The receiving, determining, and deploying steps are carried out by an artificial intelligence/machine learning system trained in a supervised or unsupervised manner using a collision training dataset including sensor data, operational state data, and resulting outcomes.

In another illustrative embodiment, the present disclosure provides a non-transitory computer-readable medium including instructions stored in a memory and executed by a processor to carry out steps for automatically avoiding a vehicle collision, the steps including: receiving sensor data from a sensor coupled to a vehicle and operational state data from an electronic control unit of the vehicle; determining that an impact event is impending based on the sensor data and the operational state data; determining that the impact event exceeds a predetermined severity threshold; and deploying a collision avoidance measure to avoid or lessen a severity of the impact event. The collision avoidance measure may include one or more of automatic steering and automatic braking. The collision avoidance measure may also include automatic tire flattening. The collision avoidance measure may further include vehicle anchor deployment. The sensor includes one or more of a camera, a lidar sensor, a radar sensor, and an ultrasonic sensor. The operational state data includes one or more of a speed of the vehicle, a trajectory of the vehicle, a steering state of the vehicle, a braking state of the vehicle, and a road friction state of the vehicle. The receiving, determining, and deploying steps are carried out by an artificial intelligence/machine learning system trained in a supervised or unsupervised manner using a collision training dataset including sensor data, operational state data, and resulting outcomes.

In a further illustrative embodiment, the present disclosure provides a system for automatically avoiding a vehicle collision, the system including: a collision avoidance measure coupled to a vehicle and operable for avoiding or lessening a severity of an impact event; and an artificial intelligence/machine learning system including instructions stored in a memory and executed by a processor to carry out steps including: receiving sensor data from a sensor coupled to the vehicle and operational state data from an electronic control unit of the vehicle; determining that the impact event is impending based on the sensor data and the operational state data; determining that the impact event exceeds a predetermined severity threshold; and deploying the collision avoidance measure to avoid or lessen the severity of the impact event. The collision avoidance measure may include one or more of an automatic steering system and an automatic braking system. The collision avoidance measure may also include an automatic tire flattening system. The collision avoidance measure may further include a vehicle anchor deployment system. The sensor includes one or more of a camera, a lidar sensor, a radar sensor, and an ultrasonic sensor. The operational state data includes one or more of a speed of the vehicle, a trajectory of the vehicle, a steering state of the vehicle, a braking state of the vehicle, and a road friction state of the vehicle.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a schematic diagram illustrating one embodiment of the vehicle collision avoidance system of the present disclosure;

FIG. 2 is a schematic diagram illustrating one embodiment of vehicle collision avoidance method of the present disclosure;

FIG. 3 is a network diagram of a cloud-based system for implementing the various algorithms and functions of the present disclosure;

FIG. 4 is a block diagram of a server that may be used in the cloud-based system of FIG. 3 or stand-alone; and

FIG. 5 is a block diagram of a user device that may be used in the cloud-based system of FIG. 3 or stand-alone.

### DETAILED DESCRIPTION

Again, the present disclosure provides a method and system for collision avoidance that goes beyond automatic steering and braking. A trained artificial intelligence (AI)/machine learning (ML) system is used to detect an impending impact event that exceeds a predetermined severity threshold based on received sensor and vehicle operational data. Upon detecting such an impending impact event, vehicle systems are deployed to avoid or lessen the severity of the impending impact event. These vehicle systems include automatic steering and braking, and automatic tire flattening and vehicle anchor deployment which are intended to stop or slow the vehicle before impact.

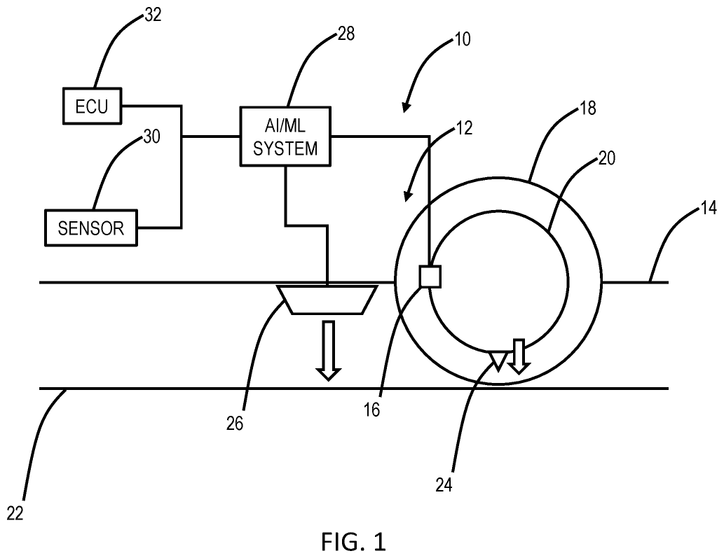

FIG. 1 is a schematic diagram illustrating one embodiment of the vehicle collision avoidance system 10 of the present disclosure. The system 10 includes a collision avoidance measure 12 coupled to a vehicle 14 and operable for avoiding or lessening a severity of an impact event. The collision avoidance measure 12 may include one or more of an automatic steering system and an automatic braking system, both of which are well known to those of ordinary skill in the art.

The collision avoidance measure 12 may also or alternatively include an automatic tire flattening system. The automatic tire flattening system includes a relief valve 16 that is configured to instantaneously or rapidly release substantially all pressure from a tire 18 of the vehicle 14 when actuated, such that a rim 20 of the vehicle 14 instantaneously or rapidly contacts the road surface 22, thereby instantaneously or rapidly slowing the vehicle 14 via friction, with each tire 18 optionally including such a relief valve 16.

The collision avoidance measure 12 may further or alternatively include a vehicle anchor deployment system. The vehicle anchor deployment system includes one or more protruding structures 24 that are circumferentially coupled to and extending from a rim 20 of the vehicle 14 and configured to instantaneously or rapidly contact the road surface 22 when substantially all pressure is released from the corresponding tire 18 of the vehicle 14 when actuated, such that the one or more protruding structures 24 instantaneously or rapidly slow the vehicle 14 via friction, with each rim 20 optionally including such one or more protruding structures 24. The one or more protruding structures 24 may be nubs, spikes, teeth, or simply grooved portions of the corresponding rim 20. Alternatively, the vehicle anchor deployment system includes an anchor member 26 that is selectively deployed downwards and/or outwards from the bottom of the vehicle 14 and configured to instantaneously or rapidly contact the road surface 22 when actuated, such that the anchor member 26 instantaneously or rapidly slows the vehicle 14 via friction, with each side or corner of the vehicle 14 optionally including such anchor member 26. The anchor member 26 may a prismatic structure, spike, weighted member, or the like.

The system 10 also includes an AI/ML system 28 including instructions stored in a memory and executed by a processor to carry out steps including receiving sensor data from a sensor 30 coupled to the vehicle 14 and operational state data from an electronic control unit 32 of the vehicle 14. The steps also include determining that the impact event is impending based on the sensor data and the operational state data and determining that the impact event exceeds a predetermined severity threshold. In this manner, the prospect of a more minor impact event may not trigger the collision avoidance measures 12 of the present disclosure, while the prospect of a more severe impact event will trigger the collision avoidance measures 12 of the present disclosure. The steps further include deploying the collision avoidance measure 12 to avoid or lessen the severity of the impact event.

The sensor 30 utilized includes one or more of a camera, a lidar sensor, a radar sensor, an ultrasonic sensor, etc., representing a perception sensor that visualizes, captures, and tracks the surroundings and objects around the vehicle 14. The operational state data includes information about the operation of the vehicle 14, such as a speed of the vehicle 14, a trajectory of the vehicle 14, a steering state of the vehicle 14, a braking state of the vehicle 14, a road friction state of the vehicle, etc. Other operational state data may be utilized as well.

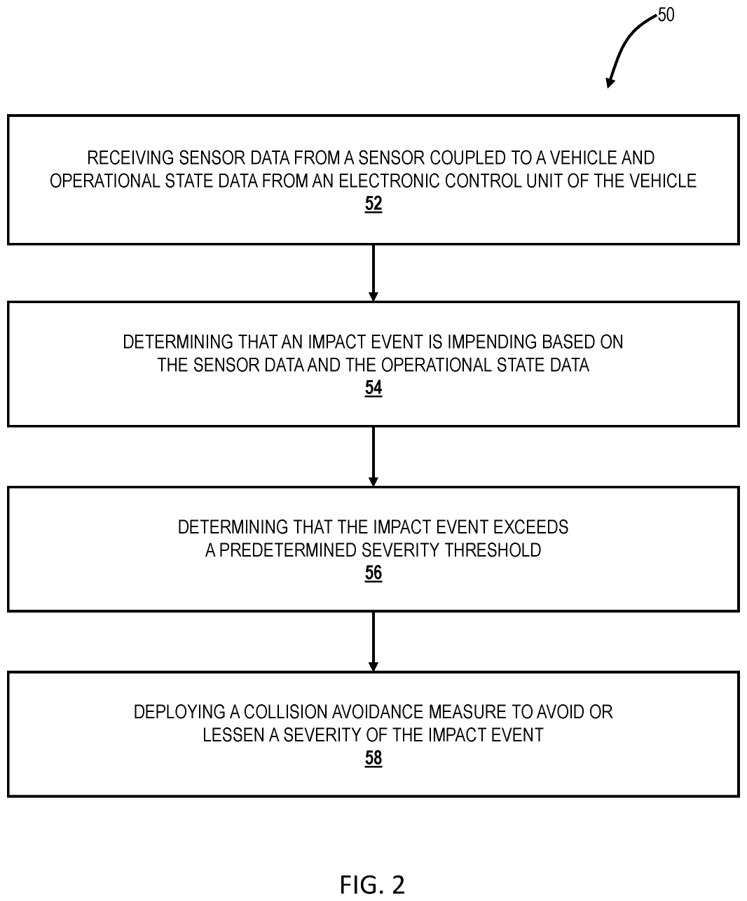

FIG. 2 is a schematic diagram illustrating one embodiment of vehicle collision avoidance method 50 of the present disclosure. The method 50 includes receiving sensor data from a sensor coupled to a vehicle and operational state data from an electronic control unit of the vehicle (step 52). The method 50 also includes determining that an impact event is impending based on the sensor data and the operational state data (step 54) and determining that the impact event exceeds a predetermined severity threshold (step 56). The method 50 further includes deploying a collision avoidance measure to avoid or lessen a severity of the impact event (step 58). The collision avoidance measure may include one or more of automatic steering and automatic braking. The collision avoidance measure may also include automatic tire flattening. The collision avoidance measure may further include vehicle anchor deployment. The sensor includes one or more of a camera, a lidar sensor, a radar sensor, and an ultrasonic sensor. The operational state data includes one or more of a speed of the vehicle, a trajectory of the vehicle, a steering state of the vehicle, a braking state of the vehicle, and a road friction state of the vehicle. The receiving, determining, and deploying steps are carried out by an artificial intelligence/machine learning system trained in a supervised or unsupervised manner using a collision training dataset including sensor data, operational state data, and resulting outcomes.

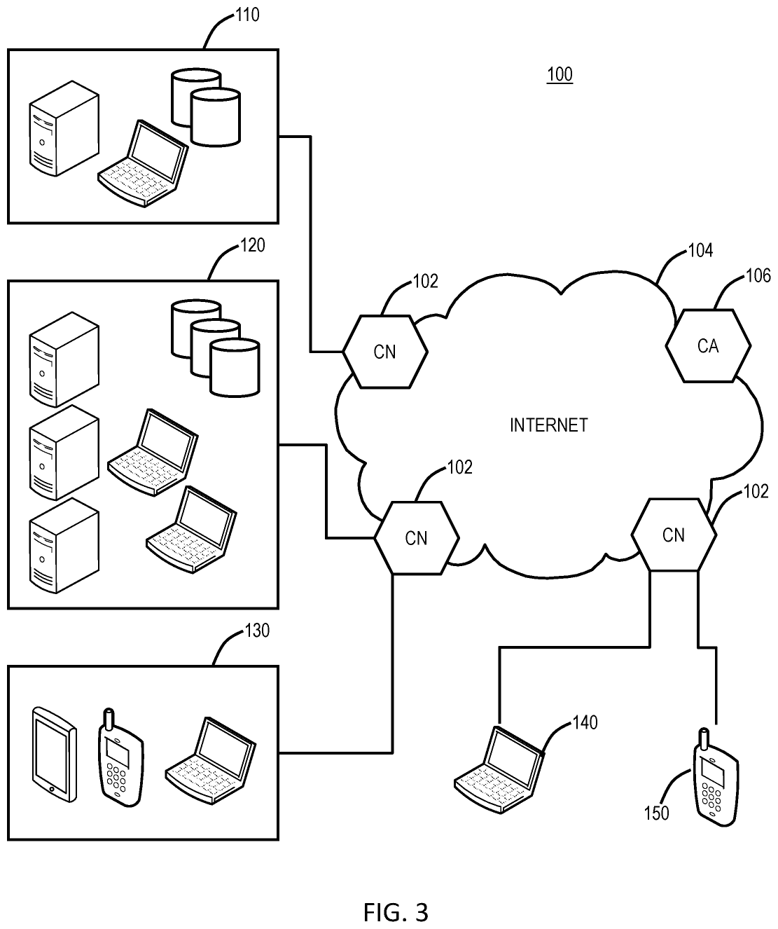

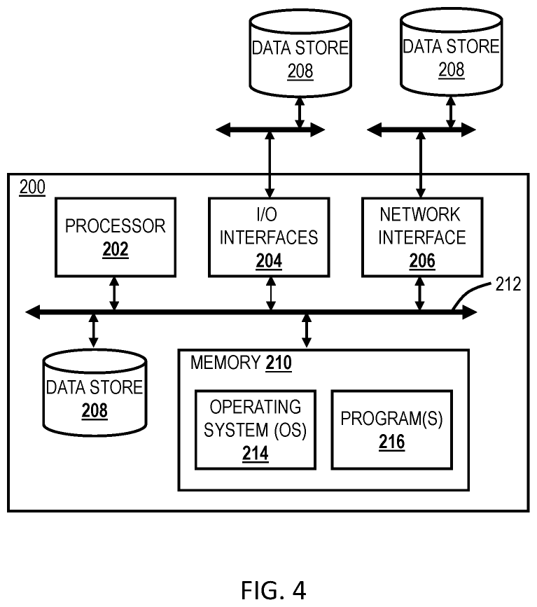

FIG. 3 is a network diagram of a cloud-based system 100 for implementing various cloud-based algorithms and functions of the present disclosure. The cloud-based system 100 includes one or more cloud nodes (CNs) 102 communicatively coupled to the Internet 104 or the like. The cloud nodes 102 may be implemented as a server 200 (as illustrated in FIG. 4) or the like and can be geographically diverse from one another, such as located at various data centers around the country or globe. Further, the cloud-based system 100 can include one or more central authority (CA) nodes 106, which similarly can be implemented as the server 200 and be connected to the CNs 102. For illustration purposes, the cloud-based system 100 can connect to a regional office 110, headquarters 120, various employee's homes 130, laptops/desktops 140, and mobile devices 150, each of which can be communicatively coupled to one of the CNs 102. These locations 110, 120, and 130, and devices 140 and 150 are shown for illustrative purposes, and those skilled in the art will recognize there are various access scenarios to the cloud-based system 100, all of which are contemplated herein. The devices 140 and 150 can be so-called road warriors, i.e., users off-site, on-the-road, etc. The cloud-based system 100 can be a private cloud, a public cloud, a combination of a private cloud and a public cloud (hybrid cloud), or the like.

The cloud-based system 100 can provide any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 110, 120, and 130 and devices 140 and 150. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 100 is illustrated herein as one example embodiment of a cloud-based system, and those of ordinary skill in the art will recognize the systems and methods described herein are not necessarily limited thereby.

FIG. 4 is a block diagram of a server 200, which may be used in the cloud-based system 100 (FIG. 3), in other systems, or stand-alone, such as in a vehicle system. For example, the CNs 102 (FIG. 3) and the central authority nodes 106 (FIG. 3) may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 3 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but is not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104 (FIG. 3). The network interface 206 may include, for example, an Ethernet card or adapter (e.g., 10BaseT, Fast Ethernet, Gigabit Ethernet, or 10 GbE) or a Wireless Local Area Network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., a SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable operating system (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable medium having computer-readable code stored thereon for programming a computer, server, appliance, device, processor, circuit, etc. each of which may include a processor to perform functions as described and claimed herein. Examples of such computer-readable mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

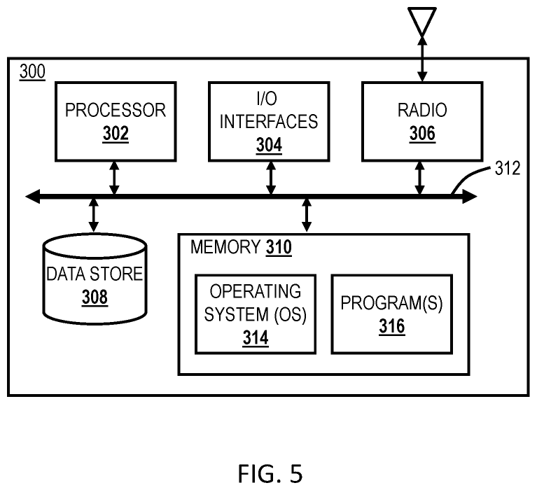

FIG. 5 is a block diagram of a user device 300, which may be used in the cloud-based system 100 (FIG. 3), as part of a network, or stand-alone, such as in a vehicle system. Again, the user device 300 can be a vehicle, a smartphone, a tablet, a smartwatch, an Internet of Things (IoT) device, a laptop, a virtual reality (VR) headset, etc. The user device 300 can be a digital device that, in terms of hardware architecture, generally includes a processor 302, I/O interfaces 304, a radio 306, a data store 308, and memory 310. It should be appreciated by those of ordinary skill in the art that FIG. 4 depicts the user device 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 can be, for example, but is not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 306 enables wireless communication to an external access device or network. Any number of suitable wireless data communication protocols, techniques, or methodologies can be supported by the radio 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

Again, the memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 5, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network, such as the cloud-based system 100 (FIG. 3).

Again, the present disclosure provides a method and system for collision avoidance that goes beyond automatic steering and braking. A trained artificial intelligence (AI)/machine learning (ML) system is used to detect an impending impact event that exceeds a predetermined severity threshold based on received sensor and vehicle operational data. Upon detecting such an impending impact event, vehicle systems are deployed to avoid or lessen the severity of the impending impact event. These vehicle systems include automatic steering and braking, and automatic tire flattening and vehicle anchor deployment which are intended to stop or slow the vehicle before impact.

Although the present disclosure is illustrated and described herein with reference to illustrative embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A method for automatically avoiding a vehicle collision, the method comprising:
receiving sensor data from a sensor coupled to a vehicle and operational state data from an electronic control unit of the vehicle;
determining that an impact event is impending based on the sensor data and the operational state data;
determining that the impact event exceeds a predetermined severity threshold; and
deploying a collision avoidance measure to avoid or lessen a severity of the impact event.

2. The method of claim 1, wherein the collision avoidance measure comprises one or more of automatic steering and automatic braking.

3. The method of claim 1, wherein the collision avoidance measure comprises automatic tire flattening.

4. The method of claim 1, wherein the collision avoidance measure comprises vehicle anchor deployment.

5. The method of claim 1, wherein the sensor comprises one or more of a camera, a lidar sensor, a radar sensor, and an ultrasonic sensor.

6. The method of claim 1, wherein the operational state data comprises one or more of a speed of the vehicle, a trajectory of the vehicle, a steering state of the vehicle, a braking state of the vehicle, and a road friction state of the vehicle.

7. The method of claim 1, wherein the receiving, determining, and deploying steps are carried out by an artificial intelligence/machine learning system trained in a supervised or unsupervised manner using a collision training dataset comprising sensor data, operational state data, and resulting outcomes.

8. A non-transitory computer-readable medium comprising instructions stored in a memory and executed by a processor to carry out steps for automatically avoiding a vehicle collision, the steps comprising:
receiving sensor data from a sensor coupled to a vehicle and operational state data from an electronic control unit of the vehicle;
determining that an impact event is impending based on the sensor data and the operational state data;
determining that the impact event exceeds a predetermined severity threshold; and
deploying a collision avoidance measure to avoid or lessen a severity of the impact event.

9. The non-transitory computer-readable medium of claim 8, wherein the collision avoidance measure comprises one or more of automatic steering and automatic braking.

10. The non-transitory computer-readable medium of claim 8, wherein the collision avoidance measure comprises automatic tire flattening.

11. The non-transitory computer-readable medium of claim 8, wherein the collision avoidance measure comprises vehicle anchor deployment.

12. The non-transitory computer-readable medium of claim 8, wherein the sensor comprises one or more of a camera, a lidar sensor, a radar sensor, and an ultrasonic sensor.

13. The non-transitory computer-readable medium of claim 8, wherein the operational state data comprises one or more of a speed of the vehicle, a trajectory of the vehicle, a steering state of the vehicle, a braking state of the vehicle, and a road friction state of the vehicle.

14. The non-transitory computer-readable medium of claim 8, wherein the receiving, determining, and deploying steps are carried out by an artificial intelligence/machine learning system trained in a supervised or unsupervised manner using a collision training dataset comprising sensor data, operational state data, and resulting outcomes.

15. A system for automatically avoiding a vehicle collision, the system comprising:
a collision avoidance measure coupled to a vehicle and operable for avoiding or lessening a severity of an impact event; and
an artificial intelligence/machine learning system comprising instructions stored in a memory and executed by a processor to carry out steps comprising:
receiving sensor data from a sensor coupled to the vehicle and operational state data from an electronic control unit of the vehicle;
determining that the impact event is impending based on the sensor data and the operational state data;
determining that the impact event exceeds a predetermined severity threshold; and
deploying the collision avoidance measure to avoid or lessen the severity of the impact event.

16. The system of claim 15, wherein the collision avoidance measure comprises one or more of an automatic steering system and an automatic braking system.

17. The system of claim 15, wherein the collision avoidance measure comprises an automatic tire flattening system.

18. The system of claim 15, wherein the collision avoidance measure comprises a vehicle anchor deployment system.

19. The system of claim 15, wherein the sensor comprises one or more of a camera, a lidar sensor, a radar sensor, and an ultrasonic sensor.

20. The system of claim 15, wherein the operational state data comprises one or more of a speed of the vehicle, a trajectory of the vehicle, a steering state of the vehicle, a braking state of the vehicle, and a road friction state of the vehicle.
